(19) United States
(12) Patent Application Publication
(10) Pub. No.: US 2026/0211075 A1
(43) Pub. Date: Jul. 23, 2026

(54) DIRECTION ESTIMATION DEVICE AND DIRECTION ESTIMATION METHOD

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Yufeng FU, Nisshin-shi (JP); Shinji YAMAURA, Nisshin-shi (JP)

(21) Appl. No.: 19/367,241

(22) Filed: Oct. 23, 2025

(30) Foreign Application Priority Data
Jan. 23, 2025 (JP) 2025-009994

(51) Int. Cl. G01S 3/02; G01S 3/04

(52) U.S. Cl. CPC G01S 3/023; G01S 3/043

(57) ABSTRACT

A direction estimation device includes a receiver that receives reflected radio waves at a predetermined frequency from an object, and at least one of a circuit or a processor with memory storing executable program code. The receiver has antenna elements, at least some of which are spaced wider than a reference spacing. The circuit or processor determines spectral data corresponding to an unknown direction of the object based on the received signal. Iterative processes are performed to determine a mean and covariance of a posterior distribution, calculate a log-likelihood of the spectral data, and update hyperparameters and noise variance. The direction of the object is estimated based on the spectral data when a termination condition is met, with hyperparameters updated using probability distributions as priors.

### CROSS REFERENCE TO RELATED APPLICATION

This application is based on and claims the benefits of priority of Japanese Patent Application No. 2025-009994 filed on Jan. 23, 2025. The entire disclosure of which is incorporated herein by reference.

### TECHNICAL FIELD

The present disclosure relates to a direction estimation device and a direction estimation method for estimating a direction of an object using radio waves.

### BACKGROUND ART

Conventional direction estimation devices use large-aperture array antennas in which multiple antenna elements are arranged at intervals wider than a predetermined reference spacing.

### SUMMARY

According to at least one embodiment, a direction estimation device includes a receiver that receives a reflected radio wave at a predetermined frequency from an object, and at least one of (i) a circuit and (ii) a processor having a memory storing computer program code executable by the processor. The receiver has antenna elements, at least a portion of which are arranged with a spacing wider than a predetermined reference spacing. The circuit or the processor determines spectral data corresponding to a direction of the object, where the direction is an unknown parameter, based on a received signal of the reflected radio wave received by the receiver. The circuit or the processor may iteratively execute, until a predetermined termination condition is satisfied, a first process for determining a mean and a covariance of a posterior distribution of the unknown parameter as the spectral data, based on the received signal as observation data, hyperparameters included in prior distributions of the unknown parameter, a variance of noise overlapped on the observation data, and a basis function determined according to an arrangement configuration of the antenna elements. The circuit or the processor may also execute a second process for determining a log-likelihood of the spectral data, which indicates likelihood of the spectral data, obtained by the first process, and a third process for updating the hyperparameters and the variance of the noise. The circuit or the processor may estimate the direction of the object based on the spectral data obtained when the termination condition is satisfied. The third process may include updating the hyperparameters using probability distributions as the prior distributions of the unknow parameter.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic configuration diagram of a direction estimation device according to a first embodiment.

FIG. 2 is an explanatory diagram for explaining an arrangement of a virtual array antenna of the direction estimation device according to the first embodiment.

FIG. 3 is an explanatory diagram for explaining characteristics of SBL (Sparse Bayesian Learning) and BLRC (Bayesian Linear Regression with Cauchy prior).

FIG. 4 is an explanatory diagram for explaining an example of a direction estimation algorithm executed by a signal processing unit of the direction estimation device according to the first embodiment.

FIG. 5 is an explanatory diagram for explaining variables of a mathematical model used for direction estimation.

FIG. 6 is an explanatory diagram for explaining variables in the direction estimation algorithm shown in FIG. 4.

FIG. 7 is a flowchart showing control processing executed by the signal processing unit of the direction estimation device according to the first embodiment.

FIG. 8 is an explanatory diagram for explaining an error alarm rate when the direction estimation is performed using BLRC.

FIG. 9 is an explanatory diagram for explaining the error alarm rate when the direction estimation is performed using a first algorithm.

FIG. 10 is an explanatory diagram for explaining target separation performance in a case where direction estimation is performed using BLRC.

FIG. 11 is an explanatory diagram for explaining the target separation performance in a case where the direction estimation is performed using the first algorithm.

FIG. 12 is a flowchart showing control processing executed by a signal processing unit of a direction estimation device according to a second embodiment.

FIG. 13 is a flowchart showing control processing executed by a signal processing unit of a direction estimation device according to a third embodiment.

FIG. 14 is a flowchart showing control processing executed by a signal processing unit of a direction estimation device according to a fourth embodiment.

FIG. 15 is an explanatory diagram for explaining pruning process of basis functions.

### DETAILED DESCRIPTION

To begin with, examples of relevant techniques will be described.

A direction estimation device according to a comparative example has a large-aperture array antenna in order to achieve cost reduction and high resolution. In the array antenna, at least some of antenna elements are arranged at intervals wider than a predetermined reference interval. The direction estimation device according to the comparative example reconstructs sparse signals by applying Bayesian linear regression with a Cauchy prior (BLRC), which uses a Cauchy distribution as prior distribution for parameters corresponding to unknown parameters.

The present inventors are examining ways to further enhance the sparsity of the array antenna. According to the investigations by the present inventors, when using a highly sparse array antenna and performing direction estimation with the BLRC of the comparative direction estimation device, it was found that the accuracy of direction estimation decreases due to large-amplitude sidelobes.

In contrast to the comparative example, according to a direction estimation device and a direction estimation method of the present disclosure, decrease in direction estimation accuracy that occurs when sparsity of an array antenna is increased can be reduced.

According to one aspect of the present disclosure, a direction estimation device includes a receiver that receives a reflected radio wave at a predetermined frequency from an object, and at least one of (i) a circuit and (ii) a processor having a memory storing computer program code executable by the processor. The receiver has antenna elements, at least a portion of which are arranged with a spacing wider than a predetermined reference spacing. The circuit or the processor determines spectral data corresponding to a direction of the object, where the direction is an unknown parameter, based on a received signal of the reflected radio wave received by the receiver. The circuit or the processor iteratively executes, until a predetermined termination condition is satisfied, a first process for determining a mean and a covariance of a posterior distribution of the unknown parameter as the spectral data, based on the received signal as observation data, hyperparameters included in prior distributions of the unknown parameter, a variance of noise overlapped on the observation data, and a basis function determined according to an arrangement configuration of the antenna elements. The circuit or the processor also executes a second process for determining a log-likelihood of the spectral data, which indicates likelihood of the spectral data, obtained by the first process, and a third process for updating the hyperparameters and the variance of the noise. The circuit or the processor estimates the direction of the object based on the spectral data obtained when the termination condition is satisfied. The third process includes updating the hyperparameters using probability distributions as the prior distributions of the unknown parameter.

According to another aspect of the present disclosure, a direction estimation method includes receiving, by antenna elements, at least a portion of which are arranged with a spacing wider than a predetermined reference spacing, a reflected radio wave at a predetermined frequency from an object. The method includes performing signal processing for determining spectral data corresponding to a direction of the object, where the direction is an unknown parameter, based on a received signal of the reflected radio wave. The signal processing includes iteratively executing, until a predetermined termination condition is satisfied, a first process for determining a mean and a covariance of a posterior distribution of the unknown parameter as the spectral data, based on the received signal as observation data, hyperparameters included in prior distributions of the unknown parameter, a variance of noise overlapped on the observation data, and a basis function determined according to an arrangement configuration of the antenna elements. The signal processing also includes a second process for determining a log-likelihood of the spectral data, which indicates likelihood of the spectral data, obtained by the first process, and a third process for updating the hyperparameters and the variance of the noise. The method includes estimating the direction of the object based on the spectral data obtained when the termination condition is satisfied. The hyperparameters are updated using probability distributions as the prior distributions of the unknown parameter in the third process.

The present inventors, as a result of intensive studies, have found that influence of large-amplitude sidelobes on accuracy of direction estimation varies greatly depending on the prior distributions of the unknown parameter. For example, it was found that when the prior distribution of the unknown parameter is a Cauchy distribution, the influence of large-amplitude sidelobes on the accuracy of direction estimation is particularly significant. The present disclosure has been devised based on the aforementioned findings discovered by the present inventors.

According to this configuration, when the hyperparameters are updated using multiple probability distributions as the prior distributions, it is possible to reduce the decrease in direction estimation accuracy compared to a case where only a Cauchy distribution is used, as in BLRC.

Hereinafter, embodiments of the present disclosure will be described with reference to the drawings. In the following embodiments, components are the same as or equivalent to those described in the preceding embodiments are denoted by the same reference numerals, and a description of the same or equivalent components may be omitted. In addition, when only a part of the components is described in an embodiment, the components described in the preceding embodiment can be applied to the other parts of the components. The respective embodiments described herein may be partially combined with each other as long as no particular problems are caused even without explicit statement of these combinations.

### First Embodiment

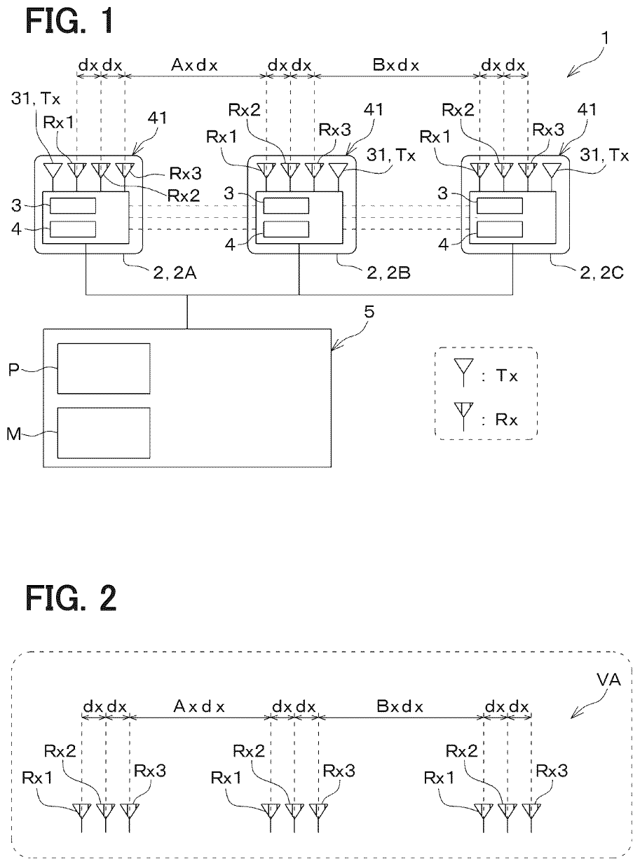

The present embodiment will be described with reference to FIGS. 1 to 11. An example will be described in which a direction estimation device 1 of the present disclosure is mounted on a vehicle and applied to a radar device that detects various objects present around the vehicle.

First, to briefly explain the radar device, the radar device emits radio waves toward a front of the vehicle and receives radio waves reflected by objects located in front of the vehicle (i.e., reflected waves), thereby determining a direction and other information of objects relative to the vehicle. More specifically, the radar device employs a frequency modulated continuous wave (FMCW) method as a signal modulation method. Furthermore, an operating frequency of the radio waves transmitted and received by the radar device is in a millimeter-wave frequency band (for example, 76.5 GHz). However, the operating frequency of the radio waves transmitted and received by the radar device is not limited to the millimeter-wave frequency band and may be a frequency other than the millimeter-wave band.

The radar device includes a direction estimation device 1 that estimates the direction of a target object. As shown in FIG. 1, the direction estimation device 1 includes transceivers 2 and a signal processing unit 5. The direction estimation device 1 of the present embodiment includes three transceivers 2: a first transceiver 2A, a second transceiver 2B, and a third transceiver 2C.

The first transceiver 2A, the second transceiver 2B, and the third transceiver 2C are arranged, for example, in a single row at predetermined intervals in a horizontal direction. The second transceiver 2B is disposed between the first transceiver 2A and the third transceiver 2C. More specifically, the first transceiver 2A and the second transceiver 2B are arranged at an interval that is an integer multiple A of a reference interval dx. In addition, the second transceiver 2B and the third transceiver 2C are arranged at an interval that is different from an interval between the first transceiver 2A and the second transceiver 2B, and is an integer multiple B of the reference interval dx. Here, the reference interval dx is one half (λ/2) of a wavelength λ of the radio wave.

Each of the transceivers 2 is constituted by an IC (Integrated Circuit) chip. Each of the transceivers 2 is interconnected so as to be synchronized with each other. Each of the transceivers 2 includes, as its main components, a transmitter 3 for transmitting radio waves and a receiver 4 for receiving radio waves.

The transmitter 3 transmits a radio wave of a predetermined frequency as a transmission wave. The transmitter 3 includes a transmission antenna 31 and a transmission generator that generates a signal to be transmitted from the transmission antenna 31 and delivers it to the transmission antenna 31. More specifically, the transmission generator generates a chirp signal whose frequency continuously changes, based on a reference signal output by an oscillator (not shown), and supplies the generated chirp signal to the transmission antenna 31.

The transmission antenna 31 transmits a radio wave corresponding to the chirp signal supplied from the transmission generator toward the front of the vehicle. The transmission antenna 31 is constituted by a single transmission antenna element Tx. The transmission antenna element Tx is disposed at a predetermined distance from a reception antenna element Rx, which will be described later.

The receiver 4 includes an array antenna 41 having receiving antenna elements Rx1 to Rx3 that receive reflected waves of the transmitted wave from an object, and a reception generator that transmits the signals received by the array antenna 41 to the signal processing unit 5. The array antenna 41 is configured as an equally spaced linear array antenna (so-called ULA: Uniform Linear Array). More specifically, each of the receiving antenna elements Rx1 to Rx3 constituting the array antenna 41 are arranged in a row at the reference interval dx along a predetermined direction.

The reception generator generates a beat signal based on the reference signal (so-called local signal) output from an oscillator (not shown), samples the beat signal, and provides it to the signal processing unit 5. Although not shown in the drawings, the reception generator is configured to include a mixer, an amplifier, an AD converter, and the like.

The signal processing unit 5 constitutes a microcontroller of the direction estimation device 1. That is, the signal processing unit 5 is an electronic control unit mainly composed of a computer equipped with a processor P and a memory M. The memory M is, for example, a read only memory (i.e., ROM), a random access memory (i.e., RAM), or the like. Various functions of the microcontroller are implemented by the processor P executing programs stored in a non-transitory tangible storage medium. The computer reads and executes various computer programs, including a direction estimation program stored in the memory M. Then, by executing computer programs such as the direction estimation program, the method corresponding to the direction estimation program (that is, the direction estimation method) is executed.

The signal processing unit 5 of the present embodiment coordinates operation of array antennas 41, which are distributedly arranged, in a monostatic manner to form, for example, a virtual array antenna VA as shown in FIG. 2. The virtual array antenna VA is configured as a sparse array antenna. That is, the virtual array antenna VA includes antenna elements, some of which are arranged at intervals wider than the reference interval dx.

The signal processing unit 5 receives signals using the large-aperture virtual array antenna VA and detects signals corresponding to objects based on the received radio waves. More specifically, the signal processing unit 5 obtains spectral data corresponding to the direction of an object, which is an unknown parameter, based on the received signal of the reflected wave received by the receiver 4.

As a method for estimating the direction of an object, there is a method in which a sparse signal is reconstructed by Bayesian linear regression (BLRC) using a Cauchy distribution as the prior distribution of parameters, based on the signal received by the virtual array antenna VA.

However, when the direction estimation is performed using BLRC, it has been found that spurious images with small amplitudes are reduced, but large side lobes are generated, which decreases the accuracy of direction estimation.

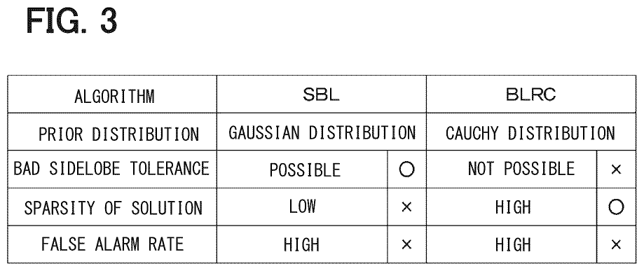

Furthermore, it has been found that the influence of large side lobes on the accuracy of the direction estimation varies greatly depending on the prior distribution of the parameters used in Bayesian estimation. For example, as shown in FIG. 3, when the prior distribution of the parameters is a Gaussian distribution, as in sparse Bayesian learning (SBL), the influence of large side lobes on the accuracy of direction estimation is small. However, when a Gaussian distribution is used, the sparsity of the solution is low, and spurious images with small amplitudes are likely to occur.

On the other hand, when the prior distribution of the parameters is a Cauchy distribution, the sparsity of the solution is high, and the occurrence of spurious images with small amplitudes is reduced, but the influence of large side lobes on the accuracy of direction estimation becomes significant.

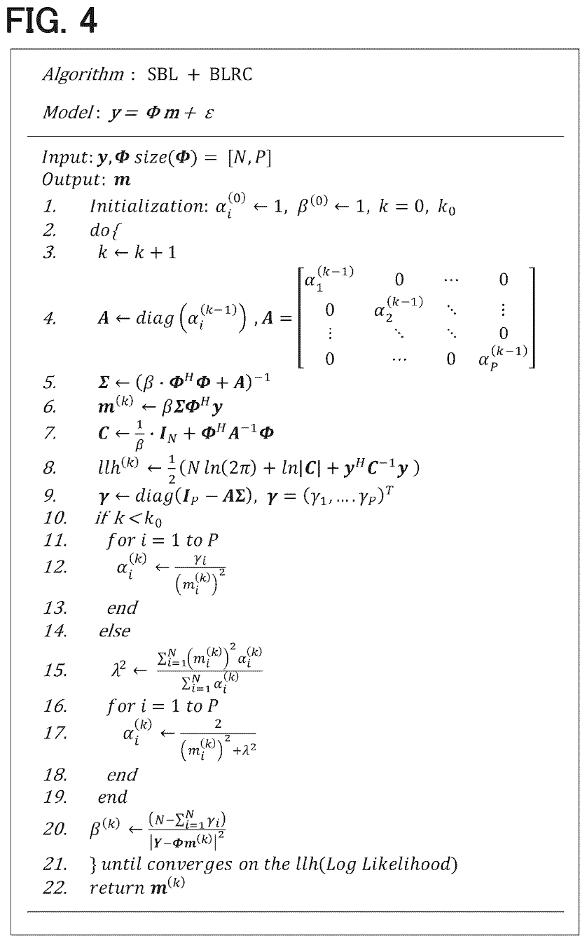

Based on the above findings, the signal processing unit 5 uses multiple probability distributions as prior distributions for the parameters. The signal processing unit 5 calculates spectral data corresponding to the direction of the object by using these probability distributions. For example, the signal processing unit 5 assumes a linear discrete mathematical model as shown in an upper part of FIG. 4. Then, the signal processing unit 5 calculates the spectral data by using the direction estimation algorithm shown in a lower part of FIG. 4.

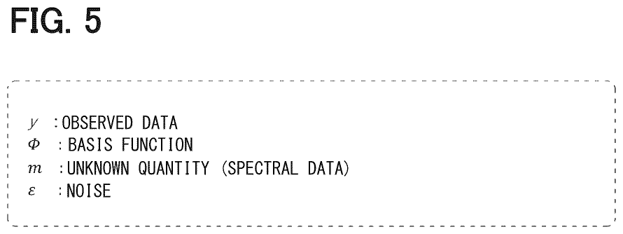

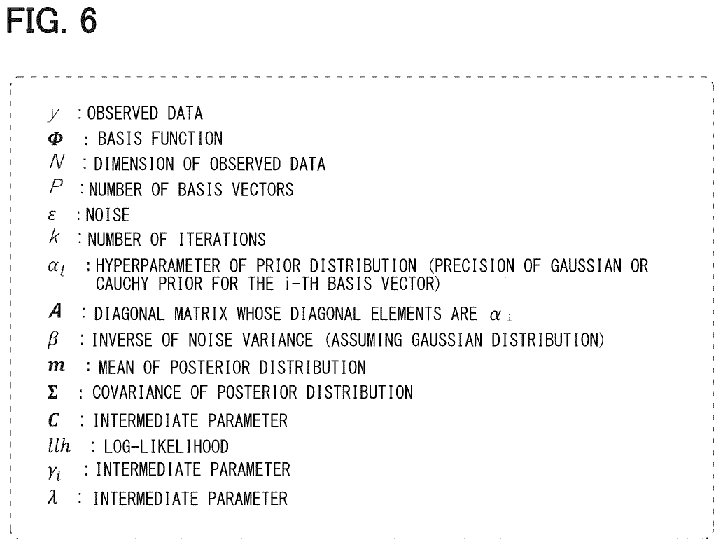

Variables and other elements of the linear discrete mathematical model shown in the upper part of FIG. 4 are as indicated in FIG. 5. Specifically, “γ” is observation data, which corresponds to the signal received by the virtual array antenna VA. “φ” is a basis function represented by an N×P matrix, which is determined by the arrangement of the antenna elements. “ω” is an unknown variable corresponding to the direction of the object, that is, the spectral data. “ε” is noise. “N” is the dimension of the observation data, that is, the number of antenna elements. “P” is the number of basis vectors, that is, the number of grids.

The meanings of the variables used in the algorithm shown in the lower part of FIG. 4 are as indicated in FIG. 6. “k” is the number of iterations of the series of processes related to direction estimation. “αi” is a hyperparameter included in the prior distribution. More specifically, “αi” is the precision when the prior distribution of the i-th basis vector is assumed to be a Gaussian distribution or a Cauchy distribution. “A” is a matrix whose diagonal elements are “αi”. “β” is a reciprocal of the variance of the noise overlapped on the observation data. More specifically, “β” is the reciprocal of the variance when “E” is assumed to follow a Gaussian distribution. “m” is the mean of the posterior distribution of the unknown variable corresponding to the spectral data. “Σ” is the covariance of the posterior distribution of the unknown variable corresponding to the spectral data. “llh” is the log-likelihood indicating the plausibility of the spectral data. “C,” “γi,” and “λ” are intermediate parameters.

The signal processing unit 5 executes a first process, a second process, and a third process in accordance with the algorithm shown in the lower part of FIG. 4. The signal processing unit 5 repeatedly executes these processes until a predetermined termination condition is satisfied. When the termination condition is satisfied, the signal processing unit 5 estimates the direction of the object based on the spectral data obtained at that time.

### <First Process>

The signal processing unit 5 uses the received signal as observation data, hyperparameters included in the prior distribution of the unknown parameter, the variance of noise overlapped on the observation data, and the basis functions determined according to the arrangement of the antenna elements. Based on this information, the signal processing unit 5 calculates the mean and covariance of the posterior distribution of the unknown parameter. More specifically, the signal processing unit 5 substitutes the values of “y”, “φ”, “β”, and “A” into Equations (1) and (2) to obtain the mean and covariance of the posterior distribution of the unknown parameter.

$$\begin{matrix}< Math 1 > & \\ \sum = {( β \cdot {Φ}^{H} Φ + A )}^{- 1} & ( 1 )\end{matrix}$$

$$\begin{matrix}< Math 2 > & \\ {m}^{( k )} = β \sum {Φ}^{H} y & ( 2 )\end{matrix}$$

The mean (in this example, m) and covariance (in this example, F) of the posterior distribution of the unknown parameter calculated in the first process correspond to the spectral data. Therefore, the first process can be interpreted as a process for obtaining the spectral data.

### <Second Process>

The signal processing unit 5 calculates the logarithmic likelihood, which indicates the plausibility of the spectral data obtained by the first process described above. The signal processing unit 5 calculates the logarithmic likelihood “llh,” for example, based on Equation (3) below.

$$\begin{matrix}< Math 3 > & \\ {llh}^{( k )} = \frac{1}{2} ( N ln ( 2 π ) + ln \vert C \vert + {y}^{H} {C}^{- 1} y ) & ( 3 )\end{matrix}$$

The intermediate parameter “C” is calculated, for example, based on Equation (4).

$$\begin{matrix}< Math 4 > & \\ C = \frac{1}{β} \cdot {I}_{N} + {Φ}^{H} {A}^{- 1} Φ & ( 4 )\end{matrix}$$

### <Third Process>

The signal processing unit 5 updates the hyperparameters and the noise. In the third process, the signal processing unit 5 updates the hyperparameters using multiple probability distributions as the prior distribution of the parameters. More specifically, when a predetermined switching condition is satisfied, the signal processing unit 5 switches the prior distribution update formula of the parameters from the update formula for the Gaussian distribution shown in Equation (5) to the update formula for the Cauchy distribution shown in Equation (6).

$$\begin{matrix}< Math 5 > & \\ {α}_{i}^{( k )} = \frac{{γ}_{i}}{{( {m}_{i}^{( k )} )}^{2}} & ( 5 )\end{matrix}$$

$$\begin{matrix}< Math 6 > & \\ {α}_{i}^{( k )} = \frac{2}{{( {m}_{i}^{( k )} )}^{2} + {λ}^{2}} & ( 6 )\end{matrix}$$

The intermediate parameter “γ” is calculated, for example, based on Equation (7). (⋅)^{T} denotes the transpose of a matrix.

$$\begin{matrix}< Math 7 > & \\ γ ← diag ( {I}_{P} - A \sum ) , γ = {( {γ}_{1} , … {γ}_{P} )}^{T} & ( 7 )\end{matrix}$$

The intermediate parameter “λ” is calculated, for example, based on Equation (8).

$$\begin{matrix}< Math 8 > & \\ {λ}^{2} = \frac{{\sum }_{i = 1}^{N} {( {m}_{i}^{( k )} )}^{2} {α}_{i}^{( k )}}{{\sum }_{i = 1}^{N} {α}_{i}^{( k )}} & ( 8 )\end{matrix}$$

More specifically, the signal processing unit 5 uses, as the switching condition, a condition that is satisfied when the number of iterations of the series of processes, namely the first process, the second process, and the third process, exceeds a predetermined reference number. Until the number of iterations of the series of processes reaches the reference number, the signal processing unit 5 updates the hyperparameters using a Gaussian distribution as the prior distribution for the parameters. Then, when the number of iterations exceeds the reference number, the signal processing unit 5 updates the hyperparameters using a Cauchy distribution as the prior distribution for the parameters.

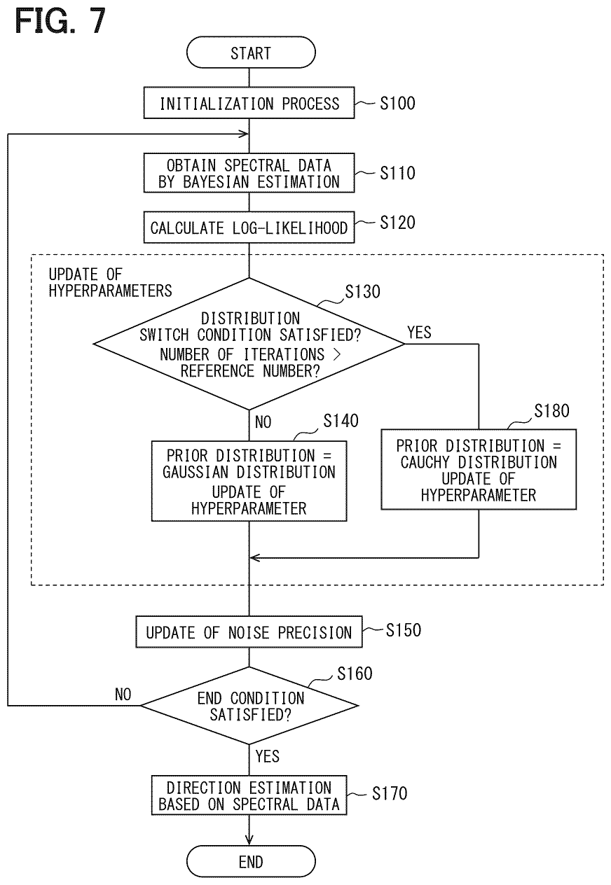

Next, the direction estimation processing executed by the signal processing unit 5 will be described with reference to FIG. 7. A processing shown in FIG. 7 is executed periodically or aperiodically by the signal processing unit 5 when a chirp signal is transmitted from each transmission antenna element Tx at a predetermined transmission cycle.

As shown in FIG. 7, in step S100, the signal processing unit 5 performs an initialization process in which initial values are set for the hyperparameter “αi”, the number of iterations “k” of the aforementioned series of processes, and the reciprocal of the variance “β” of the noise overlapped on the observation data.

In step S110, the signal processing unit 5 calculates, as spectral data, the mean and the covariance of the posterior distribution of the unknown variable by Bayesian estimation, using the received signal, the hyperparameters, the noise variance, and the basis functions determined according to the arrangement of the antenna elements. The processing in step S110 corresponds to the first processing.

In step S120, the signal processing unit 5 calculates the log-likelihood indicating the plausibility of the spectral data. The processing in step S120 corresponds to the second processing.

In step S130, the signal processing unit 5 determines whether the switching condition is satisfied. The switching condition is satisfied when the number of repetitions of the series of processes, including the first processing, the second processing, and the third processing, exceeds the predetermined reference number. The reference number may be a fixed value set in advance, or it may be a variable value that is changed according to the log-likelihood or other criteria.

If the switching condition is not satisfied in step S130, the signal processing unit 5 proceeds to step S140. In step S140, the signal processing unit 5 sets the prior distribution of the parameters to a Gaussian distribution and updates the hyperparameters. Then, in step S150, the signal processing unit 5 updates the noise variance, and then proceeds to step S160.

In step S160, the signal processing unit 5 determines whether a termination condition has been satisfied. The termination condition is set, for example, to be satisfied when the number of iterations of the series of processes exceeds a predetermined number, or when the log-likelihood exceeds a predetermined value. If the termination condition is not satisfied, the signal processing unit 5 returns to step S110. If the termination condition is satisfied, it proceeds to step S170.

On the other hand, if the switching condition is satisfied in step S130, the signal processing unit 5 proceeds to step S180. In step S180, the signal processing unit 5 sets the prior distribution of the parameters to a Cauchy distribution and updates the hyperparameter. Then, after updating the noise variance in step S150, the signal processing unit 5 proceeds to step S160 to determine whether the termination condition has been satisfied.

When the termination condition is satisfied and the signal processing unit 5 proceeds to step S170, it estimates the direction of the object based on the spectral data obtained in step S110. For example, the signal processing unit 5 identifies peaks in the spectral data that exceed a predetermined threshold, and determines the direction of the object as the azimuth corresponding to the identified peaks.

The direction estimation device 1 and the direction estimation method described above are configured to update the hyperparameters using probability distributions as the prior distributions. Accordingly, compared to a case where only a Cauchy distribution is used, as in BLRC, a decrease in direction estimation accuracy can be reduced.

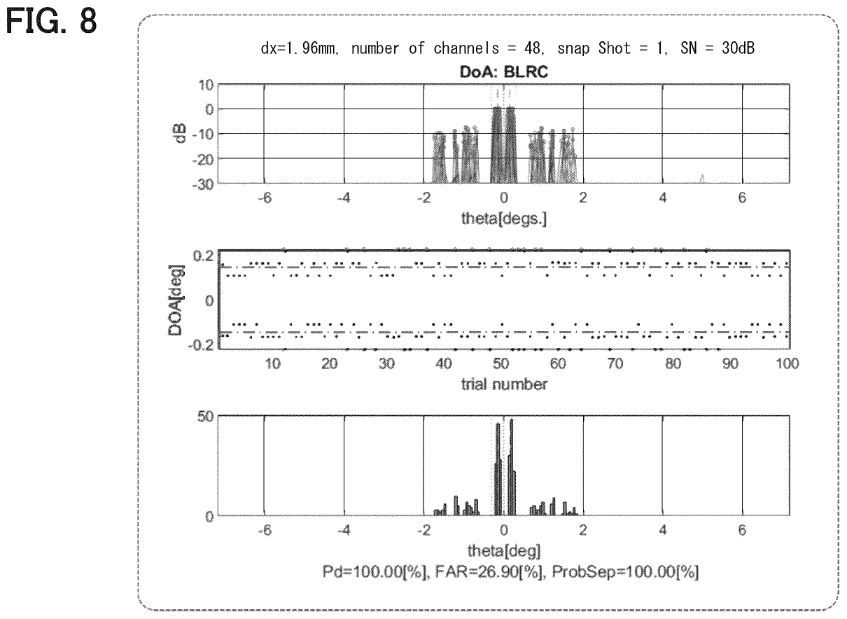

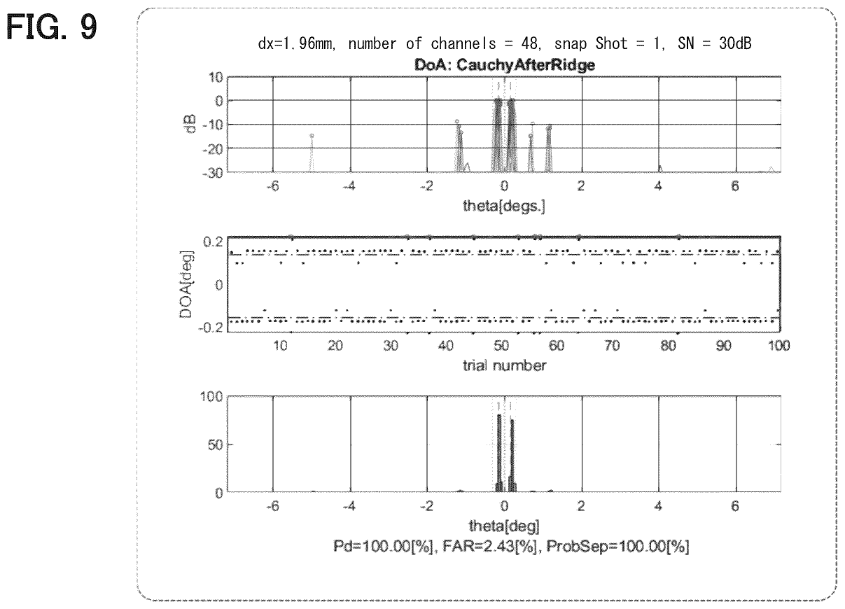

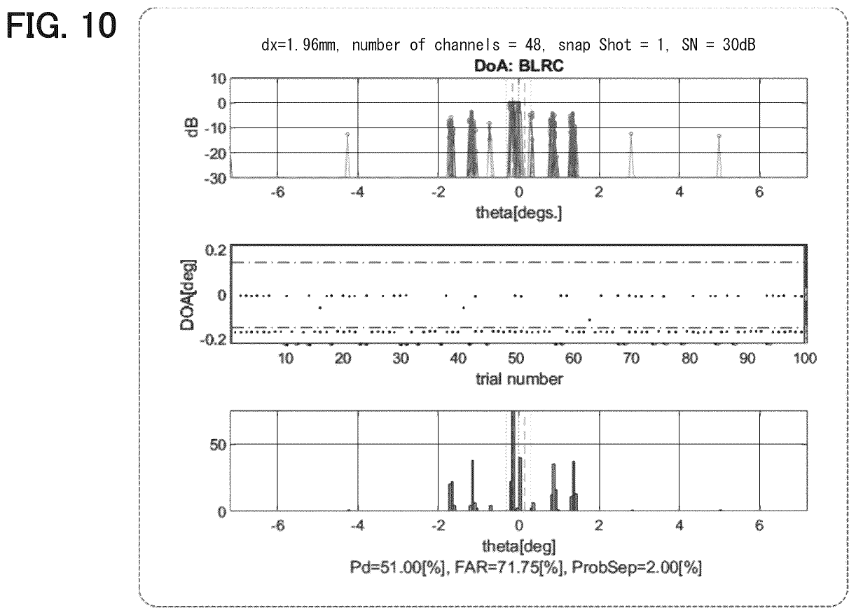

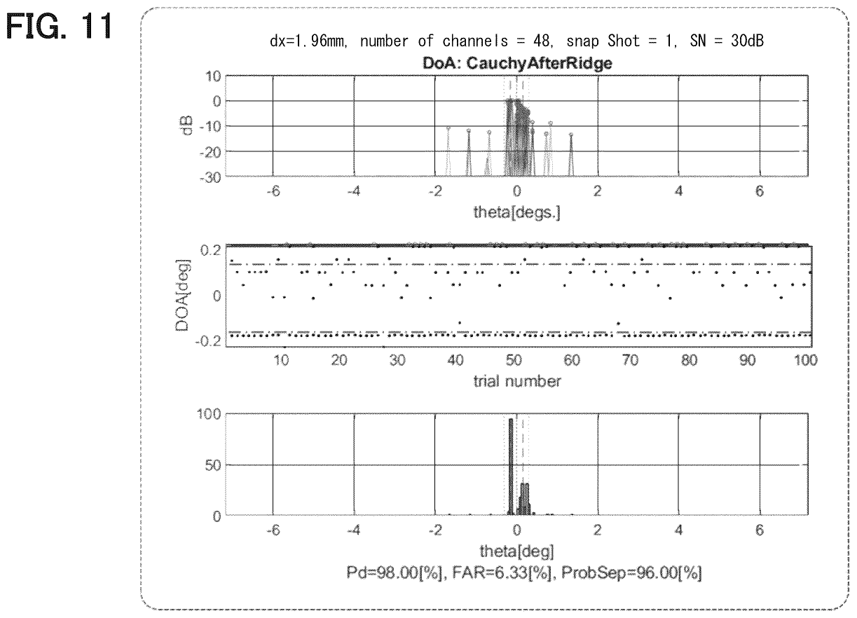

Here, FIG. 8 shows the results of the direction estimation using BLRC in a case where targets exist at azimuth angles of 0.15 degrees and −0.15 degrees, and the power levels at these azimuth angles are approximately the same (30 dB). FIG. 9 shows the results of the direction estimation using the present invention under the same conditions. In FIGS. 8 and 9, an upper section shows an overlay of 100 instances of spectral data, and a middle section shows 100 estimated azimuth angles near the target. A lower section of FIG. 8 shows the number of peak occurrences at each azimuth angle. The same applies to FIGS. 10 and 11.

As shown in FIG. 8, according to the direction estimation using BLRC, a large number of high-amplitude sidelobes were detected at azimuths where no target was present. The false alarm rate (FAR: False Alarm Rate) was 20 to 30%, and in this example, it was 27%.

On the other hand, as shown in FIG. 9, according to the direction estimation using the present invention, almost no sidelobes were detected at azimuths where no target was present. The false alarm rate was 2.4%.

FIG. 10 also shows the direction estimation results using BLRC in a case where targets with different power levels (one at 30 dB and the other at 20 dB) are present at azimuth angles of 0.15 degrees and −0.15 degrees, respectively. FIG. 11 shows the direction estimation results using the present invention under the same conditions.

As shown in FIG. 10, according to the direction estimation using BLRC, a number of peaks were detected at the intermediate position (around 0 degrees) between the two targets. The separation probability ProbSep was 2%.

On the other hand, as shown in FIG. 11, according to the direction estimation using the present invention, peaks were detected at the azimuths corresponding to each of the two targets. The separation probability (ProbSep) was 96%, representing a significant improvement over BLRC.

In addition, the direction estimation device 1 has the following features. (1) In the third processing for updating the hyperparameters, the prior distribution of the parameters is switched based on predetermined switching conditions. As a result, it is expected that malfunctions caused by using only a specific probability distribution can be reduced.
(2) As a result of the inventors' study, it was found that when the prior distribution of the parameters is a Gaussian distribution, the influence of large-amplitude sidelobes on the accuracy of direction estimation is smaller compared to the case where the prior distribution is a Cauchy distribution. In the present embodiment, in the third process for updating the hyperparameter, when the distribution switching condition is satisfied, the prior distribution of the parameters is switched from a Gaussian distribution to another distribution. With this configuration, a decrease in the accuracy of direction estimation can be appropriately reduced.

As a result of further study by the inventors, it was found that when the prior distribution of the parameters is a Gaussian distribution, the sparsity of the solution in Bayesian estimation is low, and small-amplitude false images are likely to occur. On the other hand, when the prior distribution of the parameters is a Cauchy distribution, compared to the case of a Gaussian distribution, the sparsity of the solution in Bayesian estimation is high, and the occurrence of small-amplitude false images is suppressed.

In the present embodiment, in the third process for updating the hyperparameter, when the distribution switching condition is satisfied, the prior distribution of the parameters is switched from a Gaussian distribution to a Cauchy distribution. With this configuration, a decrease in the accuracy of direction estimation can be appropriately reduced.
(4) The distribution switching condition in the present embodiment is a condition that is satisfied when the number of repetitions of the series of processes from the first process to the third process exceeds a predetermined reference number. In this way, the prior distribution may be switched when the number of iterations of the series of processes exceeds the reference number.

### Second Embodiment

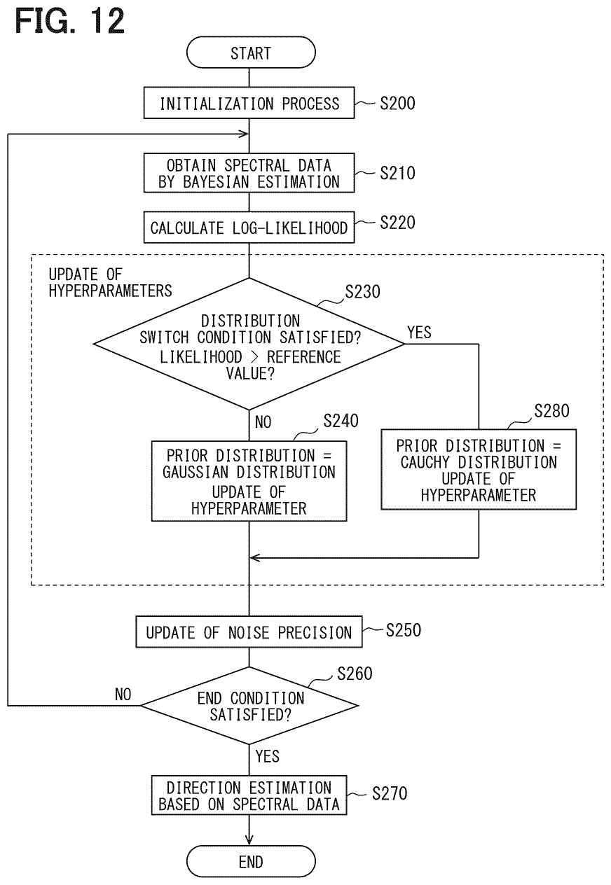

Next, a second embodiment will be described with reference to FIG. 12. In the present embodiment, differences from the first embodiment will be mainly described.

FIG. 12 is a flowchart showing a flow of the direction estimation processing executed by a signal processing unit 5 of the present embodiment. Steps S200 to S220 and steps S240 to S280 shown in FIG. 12 are the same as steps S100 to S120 and steps S140 to S180 described in the first embodiment, and thus, descriptions thereof are omitted.

As shown in FIG. 12, in step S230, the signal processing unit 5 of the present embodiment determines whether the switching condition is satisfied. The switching condition is a condition that is satisfied when the log-likelihood obtained in step S220 exceeds a predetermined reference value. The reference value may be a preset fixed value, or it may be a variable value that is changed according to the number of iterations or the like.

When the switching condition is not satisfied, the signal processing unit 5 proceeds to step S240 and sets the prior distribution of the parameters to a Gaussian distribution. When the switching condition is satisfied, it switches the prior distribution of the parameters to a Cauchy distribution.

Others are the same as those in the first embodiment. The direction estimation device 1 and the direction estimation method of the present embodiment can achieve the effects obtained from the same or equivalent configurations as those of the first embodiment, in the same manner as in the first embodiment.

In addition, the direction estimation device 1 and the like of the present embodiment have the following features. (1) In the switching condition of the present embodiment, the condition is satisfied when the log-likelihood obtained in the second processing exceeds a predetermined reference value. Accordingly, it is possible to switch the probability distribution at a stage where the plausibility of the spectral data has been secured to a certain extent.

### Modification of Second Embodiment

The switching condition may be, for example, a condition that is satisfied when the number of iterations of a series of processes such as the first to third processes exceeds a reference number, or when the log-likelihood obtained in the second process exceeds a predetermined reference value.

### Third Embodiment

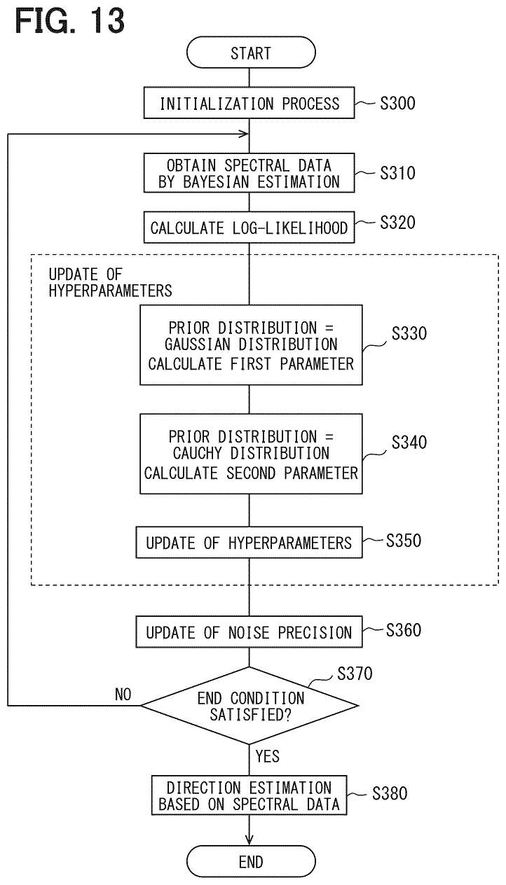

Next, a third embodiment will be described with reference to FIG. 13. In the present embodiment, differences from the first embodiment will be mainly described.

FIG. 13 is a flowchart showing a flow of the direction estimation processing executed by a signal processing unit 5 of the present embodiment. Steps S300 to S320 and steps S360 to S380 shown in FIG. 13 are the same as steps S100 to S120 and steps S150 to S170 described in the first embodiment, and thus explanations thereof will be omitted.

As shown in FIG. 13, in step S330, the signal processing unit 5 of the present embodiment sets the prior distribution of the parameters to a Gaussian distribution and obtains the hyperparameters based on the Gaussian distribution as a first parameter.

Subsequently, in step S340, the signal processing unit 5 sets the prior distribution of the parameters to a Cauchy distribution and obtains the hyperparameters based on the Cauchy distribution as a second parameter.

Subsequently, in step S350, the signal processing unit 5 updates the hyperparameters using the first parameter and the second parameter. For example, the signal processing unit 5 updates the hyperparameters for the next iteration by taking the geometric mean of the first parameter and the second parameter.

Other aspects are the same as in the first embodiment. The direction estimation device 1 and the direction estimation method of the present embodiment can achieve the effects obtained from the same or equivalent configurations as those of the first embodiment, in the same manner as in the first embodiment.

In addition, the direction estimation device 1 and the like of the present embodiment have the following features. (1) The signal processing unit 5 of the present embodiment is configured to update the hyperparameters using hyperparameters obtained for each of probability distributions. Accordingly, the hyperparameters can be updated while taking into account the characteristics of each probability distribution.

### Modification to Third Embodiment

The signal processing unit 5 may, for example, be configured to select either the first parameter or the second parameter as the next hyperparameters based on a predetermined rule. Further, the signal processing unit 5 may be configured to update the next hyperparameters as the arithmetic mean or weighted mean of the first parameter and the second parameter.

### Fourth Embodiment

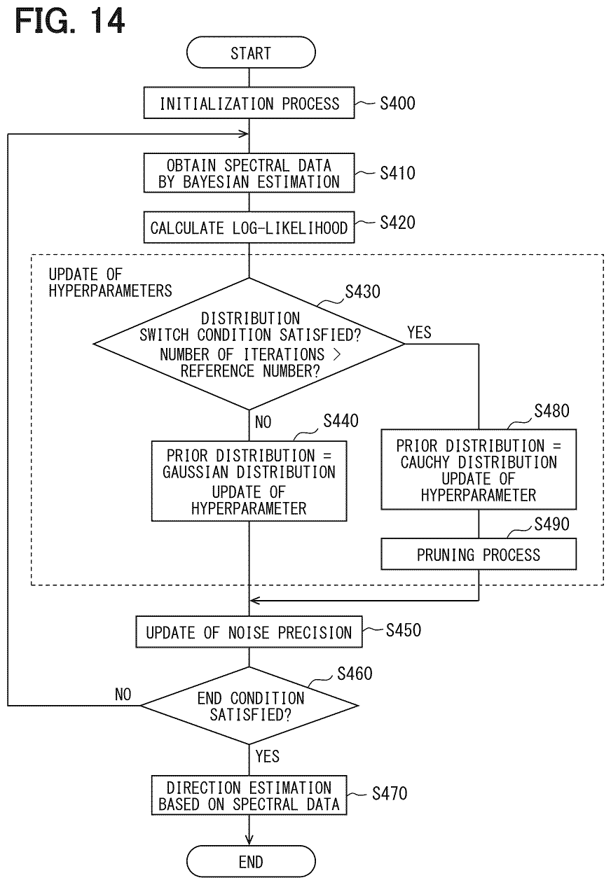

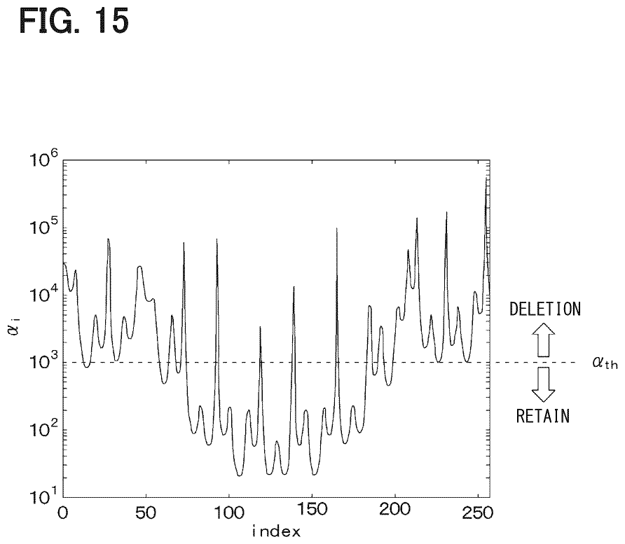

Next, a fourth embodiment will be described with reference to FIGS. 14 and 15. In the present embodiment, differences from the first embodiment will be mainly described.

FIG. 14 is a flowchart showing a flow of the direction estimation processing executed by a signal processing unit 5 of the present embodiment. Steps S400 to S480 shown in FIG. 14 are the same as steps S100 to S180 described in the first embodiment, and therefore, descriptions thereof are omitted.

As shown in FIG. 14, the signal processing unit 5 executes a pruning process for the basis functions in step S490 according to the values of the hyperparameters. In the pruning process, for example, as shown in FIG. 15, the signal processing unit 5 deletes the orientation-related parameter corresponding to the hyperparameters updated by the Cauchy distribution that exceeds a predetermined threshold from the basis functions. On the other hand, the signal processing unit 5 retains, as a reserved target, the orientation-related parameter corresponding to the hyperparameters updated by the Cauchy distribution that does not exceed the predetermined threshold. The threshold is appropriately set according to factors such as computational load and direction estimation results.

Other aspects are the same as in the first embodiment. The direction estimation device 1 and the direction estimation method of the present embodiment can achieve the effects obtained from the same or equivalent configurations as those of the first embodiment, in the same manner as in the first embodiment.

In addition, the direction estimation device 1 and the like of the present embodiment have the following features. (1) The signal processing unit 5 performs the pruning process on the basis functions according to the values of the hyperparameters. With this configuration, the calculation cost required for the series of processes can be reduced or the processing speed can be increased.

(2) The signal processing unit 5 performs the pruning process of the basis functions according to the values of the hyperparameters after the distribution switching condition is satisfied and the prior distribution of the parameters is switched from the Gaussian distribution to another distribution. By executing the pruning process of the basis functions after switching from the Gaussian distribution to another distribution, it is possible to suppress the occurrence of spurious images with small amplitudes.

### Modification of Fourth Embodiment

For example, the signal processing unit 5 may perform the pruning process of the basis functions according to the values of the hyperparameters updated by the Gaussian distribution.

### Other Embodiments

Although the representative embodiments of the present disclosure have been described above, the present disclosure should not be limited to the above-described embodiments. For example, various modifications can be made as follows.

In the above embodiment, the signal processing unit 5 is configured to switch the prior distribution of the parameters from a Gaussian distribution to another distribution when the predetermined distribution switching condition is satisfied, but this configuration is not limited thereto. For example, the signal processing unit 5 may be configured to switch the prior distribution of the parameters from the probability distribution other than a Gaussian distribution to a Gaussian distribution when the predetermined distribution switching condition is satisfied. Furthermore, the signal processing unit 5 may be configured to switch the prior distribution of the parameters three or more times.

In the above embodiment, specific examples of the antenna configuration of the direction estimation device 1 have been shown, but the antenna configuration of the direction estimation device 1 is not limited to these examples.

The array antenna 41 of the transceiver 2 may be configured as an unequally spaced linear array antenna (SLA: Sparse Linear Array) instead of an equally spaced linear array antenna. Additionally, the array antenna 41 may be configured as a multi-dimensional array antenna in which the antenna elements are arranged in two or three dimensions.

For example, the direction estimation device 1 may be configured to form a virtual array antenna VA by cooperatively operating array antennas 41, which are distributed and arranged, in a bistatic manner. Additionally, the direction estimation device 1 may be configured to form the virtual array antenna VA using a MIMO (Multiple Input and Multiple Output) scheme.

In the above embodiment, an example is described in which the direction estimation device 1 of the present disclosure is applied to a radar device mounted on a vehicle to detect various targets present around the vehicle; however, the application of the direction estimation device 1 is not limited to this. The direction estimation device 1 can also be applied to moving bodies other than vehicles, as well as to stationary radar equipment, for example.

The constituent element(s) of each of the above embodiments is/are not necessarily essential unless it is specifically stated that the constituent element(s) is/are essential in the above embodiment, or unless the constituent element(s) is/are obviously essential in principle.

Furthermore, in each of the above embodiments, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as indispensable or is obviously indispensable in view of the principle of the present disclosure.

Furthermore, in each of the above embodiments, in the case where the shape of the constituent element(s) and/or the positional relationship of the constituent element(s) are specified, the present disclosure is not necessarily limited to the shape of the constituent element(s) and/or the positional relationship of the constituent element(s) unless the embodiment specifically states that the shape of the constituent element(s) and/or the positional relationship of the constituent element(s) is/are necessary or is/are obviously essential in principle.

The control unit and the technique according to the present disclosure may be achieved by a dedicated computer provided by configuring a processor and a memory programmed to execute one or more of functions embodied by a computer program. The controller and the method described in the present disclosure may be implemented by a special purpose computer including a processor with one or more dedicated hardware logic circuits. The control unit and the technique according to the present disclosure may be achieved by one or more dedicated computers configured by a combination of a processor and a memory programmed to execute one or more functions and a processor configured by one or more hardware logic circuits. The computer program may be stored in a computer-readable non-transitory tangible storage medium as an instruction to be executed by the computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A direction estimation device comprising:
a receiver configured to receive a reflected radio wave at a predetermined frequency from an object; and
at least one of (i) a circuit and (ii) a processor having a memory storing computer program code executable by the processor, wherein
the receiver includes antenna elements, at least a portion of which are arranged with a spacing wider than a predetermined reference spacing,
the at least one of the circuit and the processor is configured to:
determine spectral data corresponding to a direction of the object, the direction being an unknown parameter, based on a received signal of the reflected radio wave received by the receiver,
iteratively execute, until a predetermined termination condition is satisfied:
a first process for determining a mean and a covariance of a posterior distribution of the unknown parameter as the spectral data, based on the received signal as observation data, hyperparameters included in prior distributions of the unknown parameter, a variance of noise overlapped on the observation data, and a basis function determined according to an arrangement configuration of the antenna elements;
a second process for determining a log-likelihood of the spectral data, which indicates likelihood of the spectral data, obtained by the first process; and
a third process for updating the hyperparameters and the variance of the noise,
estimate the direction of the object based on the spectral data obtained when the termination condition is satisfied, and
the third process includes updating the hyperparameters using probability distributions as the prior distributions of the unknow parameter.

2. The direction estimation device according to claim 1, wherein
the at least one of the circuit and the processor is configured to, in the third process, switch the prior distributions of the unknown parameter based on a predetermined distribution switching condition when updating the hyperparameters.

3. The direction estimation device according to claim 2, wherein
the at least one of the circuit and the processor is configured to, in the third process, switch the prior distributions of the unknown parameter from a Gaussian distribution to one distribution other than the Gaussian distribution when the distribution switching condition is satisfied.

4. The direction estimation device according to claim 3, wherein
the one distribution is a Cauchy distribution.

5. The direction estimation device according to claim 2, wherein
the distribution switching condition is satisfied when a number of iterations of a series of processes including the first process, the second process, and the third process exceeds a predetermined reference number.

6. The direction estimation device according to claim 2, wherein
the distribution switching condition is satisfied when the log-likelihood determined in the second process exceeds a predetermined reference value.

7. The direction estimation device according to claim 1, wherein
the at least one of the circuit and the processor is configured to, in the third process, update the hyperparameters using sets of the hyperparameters determined for each of the probability distributions.

8. The direction estimation device according to claim 1, wherein
the at least one of the circuit and the processor is configured to perform pruning of the basis function according to values of the hyperparameters.

9. The direction estimation device according to claim 3, wherein
the at least one of the circuit and the processor is configured to perform pruning of the basis function according to values of the hyperparameters after the distribution switching condition is satisfied and the prior distributions of the unknown parameter are switched from the Gaussian distribution to the one distribution.

10. A direction estimation method comprising:
receiving, by antenna elements, at least a portion of which are arranged with a spacing wider than a predetermined reference spacing, a reflected radio wave at a predetermined frequency from an object; and
performing signal processing for determining spectral data corresponding to a direction of the object, the direction being an unknown parameter, based on a received signal of the reflected radio wave, wherein
the signal processing includes iteratively executing, until a predetermined termination condition is satisfied:
a first process for determining a mean and a covariance of a posterior distribution of the unknown parameter as the spectral data, based on the received signal as observation data, hyperparameters included in prior distributions of the unknown parameter, a variance of noise overlapped on the observation data, and a basis function determined according to an arrangement configuration of the antenna elements;
a second process for determining a log-likelihood of the spectral data, which indicates likelihood of the spectral data, obtained by the first process; and
a third process for updating the hyperparameters and the variance of the noise, and
estimating the direction of the object based on the spectral data obtained when the termination condition is satisfied, and
the hyperparameters are updated using probability distributions as the prior distributions of the unknown parameter in the third process.
